(19) United States
(12) Patent Application Publication
(10) Pub. No.: US 2025/0368186 A1
(43) Pub. Date: Dec. 4, 2025

(54) ESTIMATING SURFACE CURVATURE FOR AUTONOMOUS OR SEMI AUTONOMOUS SYSTEMS AND APPLICATIONS

(71) Applicant: NVIDIA Corporation, Santa Clara, CA (US)

(72) Inventors: Cheng-Lung Chiang, Milpitas, CA (US); Rahul Ramesh Malayappan, Sunnyvale, CA (US); Yezhen Zhao, Seattle, WA (US); Ivana Stojanovic, Oakland, CA (US); Amir Akbarzadeh, Alamo, CA (US)

(21) Appl. No.: 18/675,702

(22) Filed: May 28, 2024

(51) Int. Cl. B60W 30/045; B60W 50/00; B60W 50/04; B60W 60/00; G06V 20/56

(52) U.S. Cl. CPC B60W 30/045; B60W 50/0097; B60W 50/04; B60W 60/001; G06V 20/588; B60W 2552/30

(57) ABSTRACT

In various examples, an estimated curvature associated with a driving surface may be updated or improved based on additional sources of information, such as map data and/or perception data. For instance, systems and methods are disclosed that may predict curvature (e.g., magnitudes of curvature) for one or more portions and/or points along a driving surface traversed by a machine. The predicted curvature may be determined based on one or more previous curvature predictions for the driving surface and based on a trajectory and/or a distance traveled by the machine subsequent to making those previous curvature predictions. In some instances, the predicted curvature may be updated based on one or more measured curvatures associated with the driving surface. These measured curvatures may be determined using map data associated with the driving surface and/or perception data generated from sensor data obtained using one or more sensors of the machine.

### BACKGROUND

Machines (e.g., autonomous vehicles, semi-autonomous vehicles, robots, etc.) may leverage various types of information to traverse an environment safely. For instance, current machines may be equipped with various sensors and artificial intelligence to perceive the environment surrounding the machines and make informed decisions to traverse the environment. In some examples, machines may also use the curvature of a road or other traversable surface it is following as part of its overall decision-making process. For instance, a machine may use the curvature of the road in association with path planning, adjusting steering angle, determining maximum operating speeds, making predictions about other agents in the environment, and/or performing any other operation.

However, conventional systems for estimating curvature of a driving surface may experience difficulties accurately predicting the curvature. For instance, conventional systems typically estimate road curvature using data from a single source modality, such as one or more sensors. Using data from a single source modality, however, may lead to issues estimating curvature in, for instance, scenarios in which the sensor(s) produces inaccurate and/or unreliable data. For instance, if a conventional system uses image data generated using an image sensor to determine curvature of a road, but the image sensor is obscured and/or the image data does not represent a large portion of the road based on an orientation of the image sensor with respect to the road, then the conventional system may be unable to accurately determine the curvature.

### SUMMARY

Embodiments of the present disclosure relate to estimating surface or path curvature for autonomous or semi-autonomous systems and applications. For instance, systems and methods described herein may update a curvature estimation(s) associated with a driving surface to improve the curvature estimation(s) based on one or more additional sources of information, such as map data (e.g., standard definition (SD) map data, navigation map data, etc.), perception data, and/or the like.

In contrast to conventional systems, the systems of the present disclosure, in some embodiments, may predict a curvature(s) (e.g., magnitudes of curvature) for one or more portions and/or points along a driving surface traversed by a machine. The predicted curvature(s) may be determined based at least on one or more previous curvature predictions for the driving surface. For instance, the systems of the present disclosure may use a Kalman filter or other mathematical algorithm(s) and estimate current curvature(s) based on the previous curvature prediction(s) (e.g., process model of Kalman filter). Additionally, or alternatively, the predicted curvature(s) may be determined based at least on a trajectory of the machine, and/or on a distance traveled by the machine after making the previous curvature predictions.

In some instances, the predicted curvature(s) may be updated based on one or more measured curvatures associated with the driving surface (e.g., measurement model of Kalman filter). This measured curvature(s) may, in some examples, be determined using map data associated with the driving surface. Additionally, or alternatively, the measured curvature(s) may be determined using perception data generated from sensor data obtained using one or more sensors of the machine. By updating the predicted curvature(s) based on the measured curvature(s), the system(s) of the present disclosure may more accurately and/or reliably compute a curvature(s) of a driving surface than conventional systems that do not update their curvature prediction(s)/measurement(s). Additionally, the updated curvature prediction(s) determined using the systems of the present disclosure may more accurately correspond to the actual curvature(s) of the driving surface than conventional systems since more systems, sensors, data, and/or other components are used to determine the curvature(s) of the driving surface.

### BRIEF DESCRIPTION OF THE DRAWINGS

The present systems and methods for estimating surface or path curvature for autonomous or semi-autonomous systems and applications are described in detail below with reference to the attached drawing figures, wherein:

FIG. 1 is a data flow diagram illustrating an example process for estimating curvature associated with a driving surface, in accordance with some embodiments of the present disclosure;

FIGS. 2A and 2B illustrate example curvature values that may be determined for points along a trajectory of a machine when the machine is at different locations, in accordance with some embodiments of the present disclosure;

FIG. 3 illustrates an example map associated with a driving surface that may be represented using map data, in accordance with some embodiments of the present disclosure;

FIG. 4 illustrates example perception data that may be generated based on sensor data, in accordance with some embodiments of the present disclosure;

FIG. 5 is a data flow diagram illustrating an example process in which a measurement model(s) may update curvatures based on different sources of information, in accordance with some embodiments of the present disclosure;

FIG. 6 illustrates an example graphical representation of magnitudes of curvature associated with different portions of a driving surface, in accordance with some embodiments of the present disclosure;

FIG. 7 is a flow diagram illustrating an example method for estimating curvature associated with a driving surface, in accordance with some embodiments of the present disclosure;

FIG. 8 is a flow diagram illustrating an example method for updating predicted curvatures associated with a driving surface based on map data or perception data, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

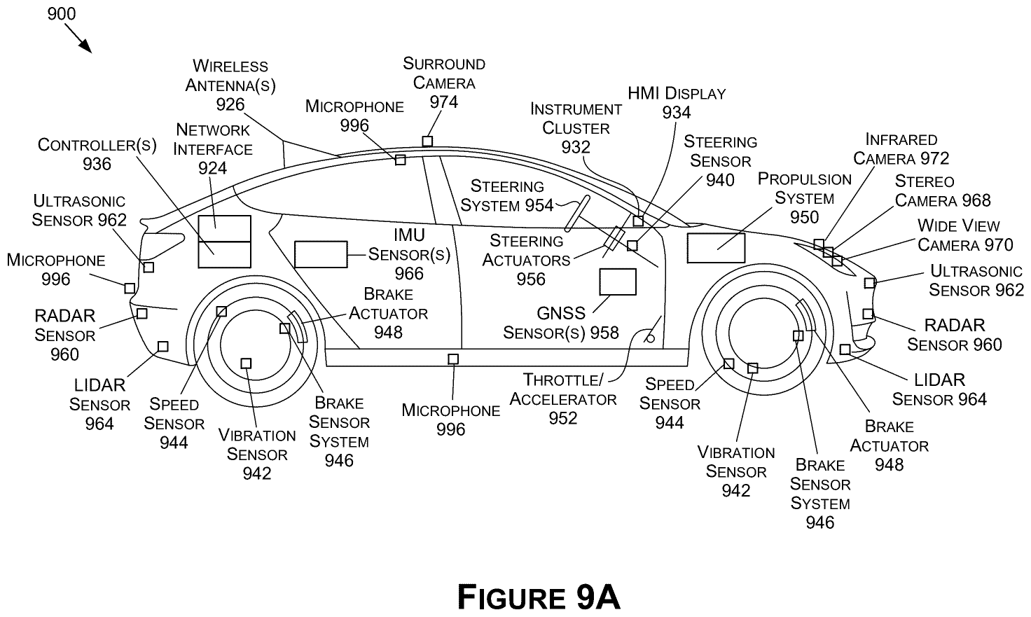

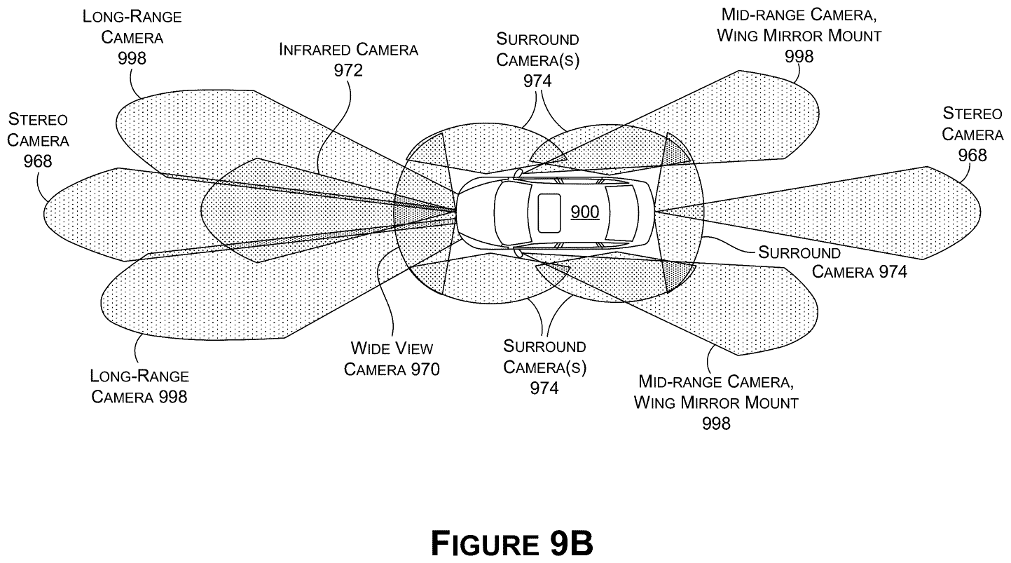

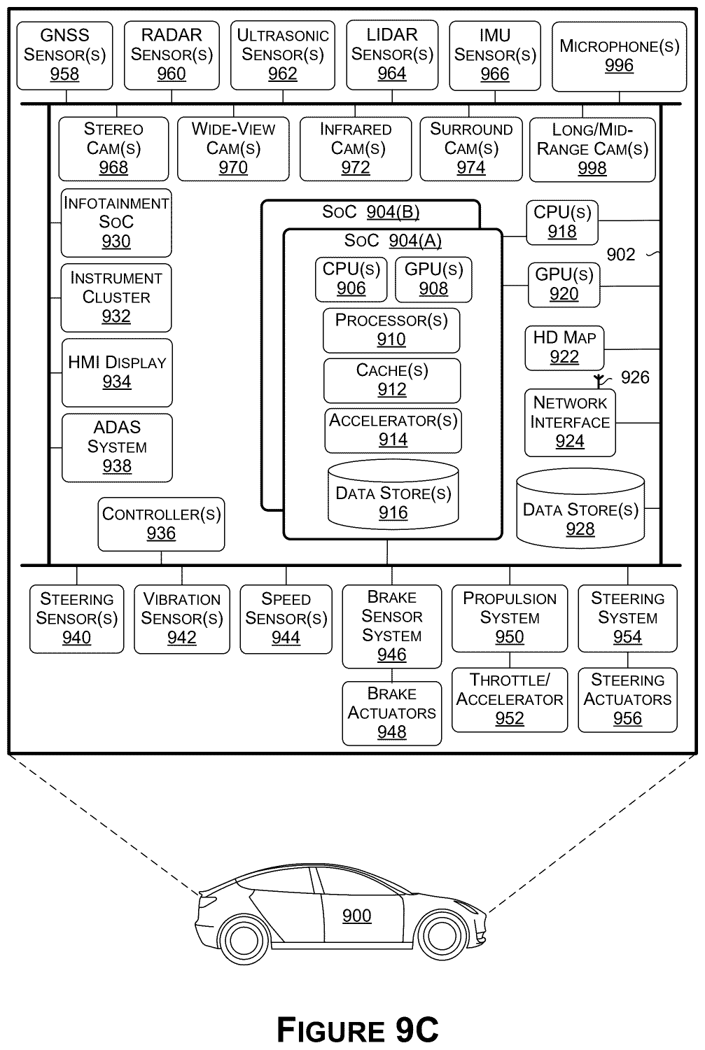

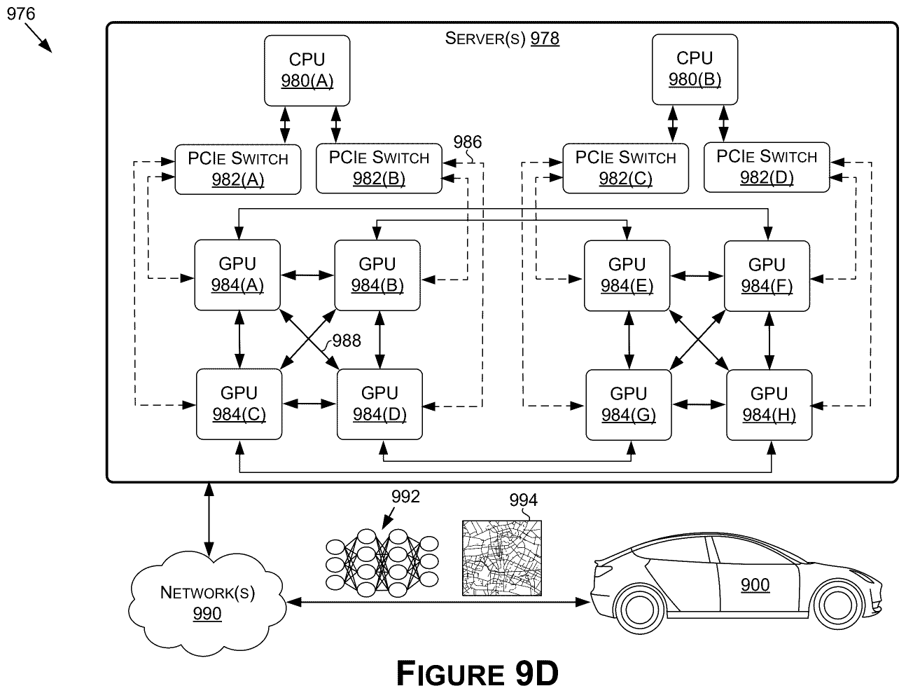

Systems and methods are disclosed related to estimating surface or path curvature for autonomous or semi-autonomous systems and applications. Although the present disclosure may be described with respect to an example autonomous or semi-autonomous vehicle or machine 900 (alternatively referred to herein as “vehicle 900,” “ego-vehicle 900,” “ego-machine 900,” or “machine 900,” an example of which is described with respect to FIGS. 9A-9D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to estimating curvature of driving surfaces, this is not intended to be limiting, and the systems and methods described herein may be used in augmented reality, virtual reality, mixed reality, robotics, security and surveillance, autonomous or semi-autonomous machine applications, and/or any other technology spaces where object detection and/or map creation may be used.

For instance, a system(s) may obtain one or more first values representative of one or more curvature predictions associated with one or more first portions of a driving surface (e.g., road surface) traversed by a machine. In some examples, a magnitude of the first value(s) may correspond to a magnitude, degree, and/or other measure of curvature associated with the first portion(s) of the driving surface. As described herein, the curvature of a driving surface—or portion of the driving surface—may mean a magnitude in which the driving surface deviates from being straight and/or how sharply the driving surface curves or bends at a given point. For example, a straight line may have a curvature magnitude of zero, while a circle with a smaller radius may have a higher magnitude of curvature, which may increase as the radius increases. Accordingly, a sharp corner or bend in a road may be associated with a high magnitude of curvature, whereas a shallow or moderate corner/bend in the road may be associated with a low magnitude of curvature.

In some examples, the system(s) may determine (e.g., predict) the curvature prediction(s) associated with the first portion(s) of the driving surface based at least on one or more second values representative of one or more previous curvature predictions associated with one or more second portions of the driving surface. For instance, the system(s) may determine the curvature prediction(s) based at least on the previous curvature prediction(s) and a trajectory of the machine. In some examples, the system(s) may use the trajectory of the machine to determine a distance traveled by the machine from a first location (e.g., current location) to a second location (e.g., previous location), and use this distance and the previous curvature prediction(s) to determine the first value(s) representative of the curvature prediction(s) (e.g., the current curvature predictions). In such an example, the second value(s) representative of the previous curvature prediction(s) may have been determined while the machine was located at the second location, and the first value(s) representative of the current curvature prediction(s) may be determined while the machine is located at the first location. Thus, the system(s) may determine the current curvature prediction(s) based on the previous curvature prediction(s) and the distance traveled by the machine after making those previous curvature prediction(s).

In some examples, the system(s) may predict the curvatures for specific points along the driving surface separated by specific offsets. By way of example, and not limitation, the system(s) may predict respective curvatures for points along the driving surface ahead of the machine at intervals of 5 meters (e.g., points located at 0 meters, 5 meters, 10 meters, 15 meters, 20 meters, and so forth from the machine). In this way, as the machine moves from the second location to the first location, one or more of the previous curvature prediction(s) may be used to linearly interpolate the new predicted curvature(s). For example, if the curvature for a point that is 5 meters from the machine is 5, and the curvature for a point that is 10 meters away from the machine is 10, then the curvature for a point that is 7.5 meters away from the machine may be interpolated as 7.5. In this way, if the machine moves 2.5 meters from the previous location where the system(s) last computed curvature (e.g., for the points at 5 meters and 10 meters), then the system(s) may determine that the curvature for the Kalman filter state corresponding to the point that is 5 meters away from the machine is a magnitude of 7.5.

As described herein, the system(s) may update/refine one or more (e.g., a subset) of first value(s) representative of the curvature prediction(s). For instance, the system(s) may update the subset of the first value(s) so that the curvature prediction(s) associated with the first portion(s) of the driving surface more accurately represent an actual curvature(s) associated with the first portion(s) of the driving surface. In some examples, the system(s) may update the subset of the curvature prediction(s) using one or more measured curvatures associated with the first portion(s) of the driving surface. As described herein, the system(s) may obtain the measured curvature(s) from various sources of data, such as map data, perception data, and/or any other type of data and/or data source. In some embodiments, the map data may correspond to a map that is less detailed than an HD map. For example, instead of relying on an HD map, a standard definition (SD) map or a navigation map may be used, where curvature may be encoded into the map data. By not relying on an HD map, and additionally leveraging live perception data, the storage requirements and accuracy requirements of an HD map-only approach are alleviated, and the two sources of information (e.g., SD or navigation map data along with perception data) provide a redundant and highly accurate and precise estimation of curvature.

For example, the system(s) may update a first subset (e.g., one, multiple, all, etc.) of the curvature prediction(s) based at least on perception data. The perception data may be determined by a perception system of the machine based at least on sensor data generated using one or more sensors of the machine. In some examples, the sensor data used to generate the perception data may include image data, LiDAR data, RADAR data, ultrasonic data, and/or other types of sensor data. In some examples, the perception data may include one or more first measured curvatures (also referred to herein as “perceived curvatures”) associated with the first portion(s) of the driving surface. Additionally, or alternatively, the system(s) may process the perception data to determine the first measured curvature(s). As described herein, the system(s) may update the first subset of the curvature prediction(s) to reduce one or more differences between the curvature prediction(s) and corresponding ones of the first measured curvature(s). As an example, if a first value of a first curvature prediction for a first portion of the drivable surface is 1, and a second value of a first measured curvature for the first portion of the drivable surface is 3, then the first value for the curvature prediction may be updated to a value of 2, 3, or some other value to reduce the difference between the two curvature values.

Additionally, or alternatively, the system(s) may also update a second subset (e.g., one, multiple, all, etc.) of the curvature prediction(s) based at least on map data. The map data may represent a map corresponding to the driving surface. In some instances, the map data may include one or more second measured curvatures (also referred to herein as “mapped curvatures”) associated with the first portion(s) of the driving surface. Additionally, or alternatively, the system(s) may process the map data to determine the second measured curvature(s). As described herein, the system(s) may update the second subset of the curvature prediction(s) to reduce one or more differences between the curvature prediction(s) and corresponding ones of the second measured curvature(s).

In some examples, the first subset of the curvature prediction(s) and the second subset of the curvature prediction(s) may include one or more of the same curvature prediction(s) associated with a same portion of the driving surface. That is, one or more of the curvature prediction(s) may be updated/refined multiple times based on the first measured curvature(s) and the second measured curvature(s). For instance, one or more of the curvature prediction(s) may be updated a first time based at least on the perception data, and then updated a second time based at least on the map data, and so forth. Additionally, or alternatively, the first measured curvature(s) and the second measured curvature(s) may be aggregated, averaged, weighted, or the like, and then the curvature prediction(s) may be updated a single time based on the combination of the first and second measured curvature(s) from the perception data and the map data.

In some examples, the system(s) may determine whether to update the curvature prediction(s) based on differences between the curvature prediction(s) and the measured curvature(s). For instance, the system(s) may evaluate the values of the curvature prediction(s) with respect to values of the measured curvature(s). In some instances, the system(s) may determine to update the values of the curvature prediction(s) if those values differ from the values of the measured curvature(s) by more than a threshold. For example, if only minor differences exist between the curvature prediction(s) and the measured curvature(s), the system(s) may only update some of the curvature predictions by a minor amount, or not at all. However, if more than minor differences (e.g., major differences) exist between the curvature prediction(s) and the measured curvature(s), then the system(s) may update the values accordingly to reduce the differences.

In some examples, the system(s) may determine to update the values of the curvature prediction(s) if those value differ from a combination or aggregate of the measured curvatures from different sources. For instance, if the system(s) determine that the curvature prediction(s) are similar to measured curvatures from the map, but differ from measured/perceived curvatures from the perception data, then the system(s) may refrain from updating the predicted curvature(s). Alternatively, or additionally, the system(s) may still update the predicted curvature(s) if, for instance, the system(s) assign a high confidence to the perception data and its corresponding measured curvatures. As another example, if the system(s) determine that the curvature prediction(s) are different (e.g., by more than a threshold) from the measured curvature(s) from both the map data and the perception data, then the system(s) may update the curvature prediction(s). Additionally, if the system(s) determine that the measured curvature(s) from both the map data and the perception data agree with one another (e.g., differ by less than a threshold), than the system(s) may update one or more of the predicted curvature(s) that disagree with the measured curvature(s).

As further described herein, the updated curvature prediction(s) (e.g., the updated first value(s)) may then be used, at least in part, to control operation of the machine. For instance, the updated curvature prediction(s) may be used for planning a path for the machine to follow, adjusting trajectory of the machine, such as adjusting steering angle, updating maximum operating speeds, and/or the like, making predictions about other agents in the environment, etc. As an example, the machine may be traveling at a speed of, for instance, 35 MPH and approaching a corner or other bend in a road. The updated curvature prediction(s) may indicate a magnitude of the bend in the road, and the system(s) may cause the machine to decrease its speed to, for instance, 25 MPH to safely navigate the bend in the road.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs) or vision language models (VLMs), systems implementing one or more multi-modal language models, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

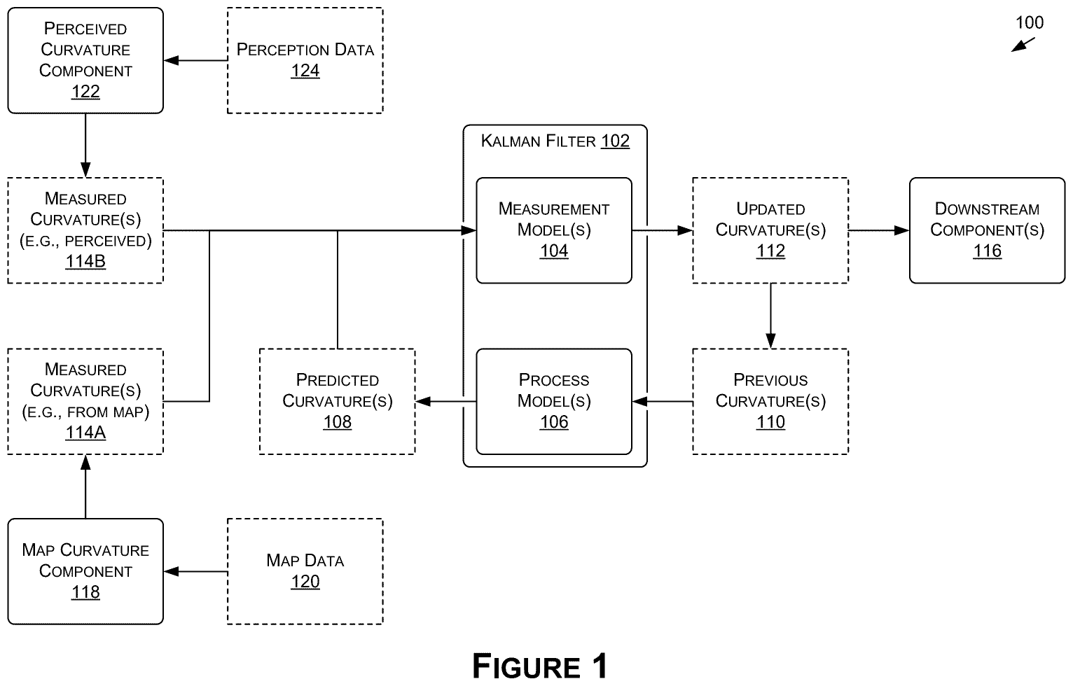

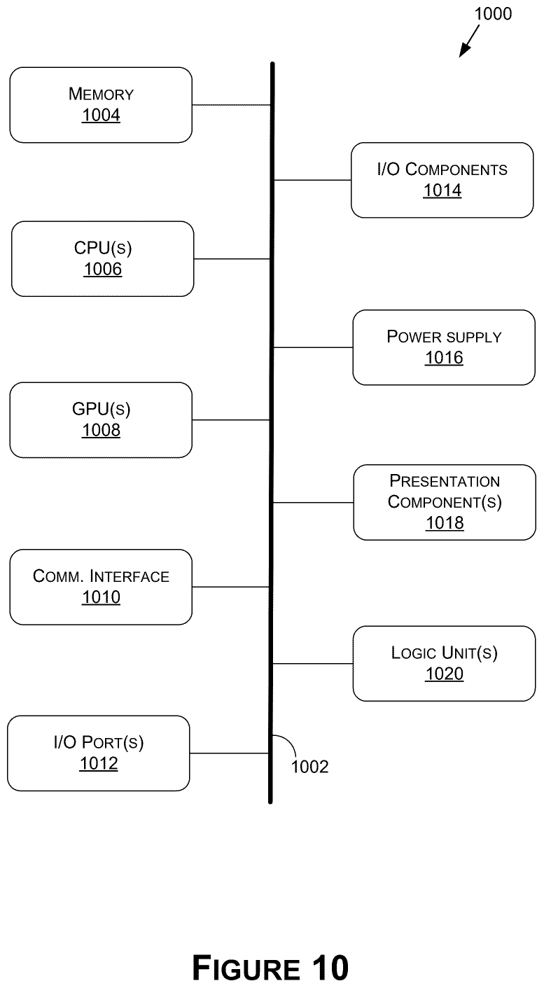

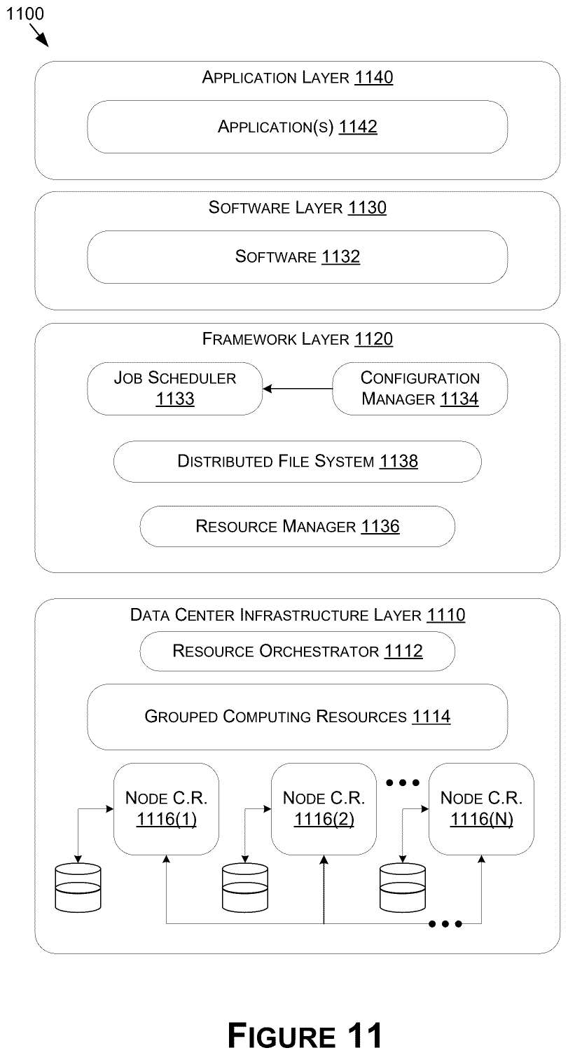

With reference to FIG. 1, FIG. 1 is a data flow diagram illustrating an example process 100 for estimating curvature associated with a driving surface, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 900 of FIGS. 9A-9D, example computing device 1000 of FIG. 10, and/or example data center 1100 of FIG. 11.

The process 100 may include a Kalman filter 102 having one or more measurement models 104 and one or more process models 106. The process model(s) 106 may determine one or more predicted curvatures 108 based at least on one or more previous curvatures 110. The measurement model(s) 104 may then determine one or more updated curvatures 112 based at least on the predicted curvature(s) 108 and one or more measured curvatures 114A and 114B. The updated curvature(s) 112 may then be provided to one or more downstream components 116, as well as re-used for the previous curvature(s) 110 for the next state of the Kalman filter 102.

As briefly mentioned above, the measurement model(s) 106 of the Kalman filter 102 may obtain the predicted curvature(s) 108 from the process model(s) 106 of the Kalman filter 102. The predicted curvature(s) 108 may be determined by the process model(s) 106 based at least on the previous curvature(s) 110 determined by the measurement model(s) 104. For instance, the previous curvature(s) 110 may be associated with a previous state (e.g., T₀₋₁) of the Kalman filter 102, and the predicted curvature(s) 108 may be associate with a present state (e.g., T₀) of the Kalman filter 102. The previous curvature(s) 110 may be obtained from the updated curvature(s) 112 for the previous state of the Kalman filter 102. In various examples, the predicted curvature(s) 108 may obtain one or more values representative of magnitudes of curvature prediction(s) associated with one or more portions of a driving surface traversed by a machine, such as the machine 900 described below with reference to FIGS. 9A-9D.

In some examples, in addition to using the previous curvature(s) 110 to determine the predicted curvature(s) 108, the process model(s) 106 may also use trajectory information (not shown) associated with the machine to determine the predicted curvature(s) 108 associated with the portion(s) of the driving surface. For example, the process model(s) 106 may use, as inputs, the previous curvature(s) 110 and a distance traveled by the machine subsequent to determining the previous curvature(s) 110 to determine the predicted curvature(s) 108. The distance traveled may correspond to a distance between the current location of the machine and a previous location of the machine where the previous curvature(s) 110 were determined from. In some examples, the trajectory information may further indicate a pose of the machine (e.g., a heading, an angle, an inclined, etc.), a speed of the machine, a velocity of the machine, an acceleration of the machine, and/or the like, which may also be included/used to determine the predicted curvature(s) 108.

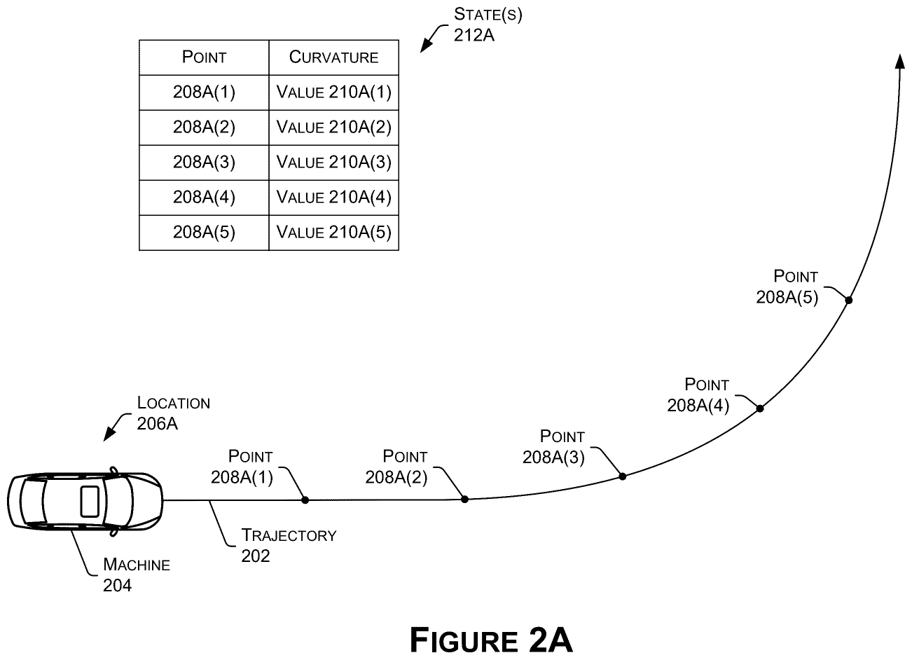

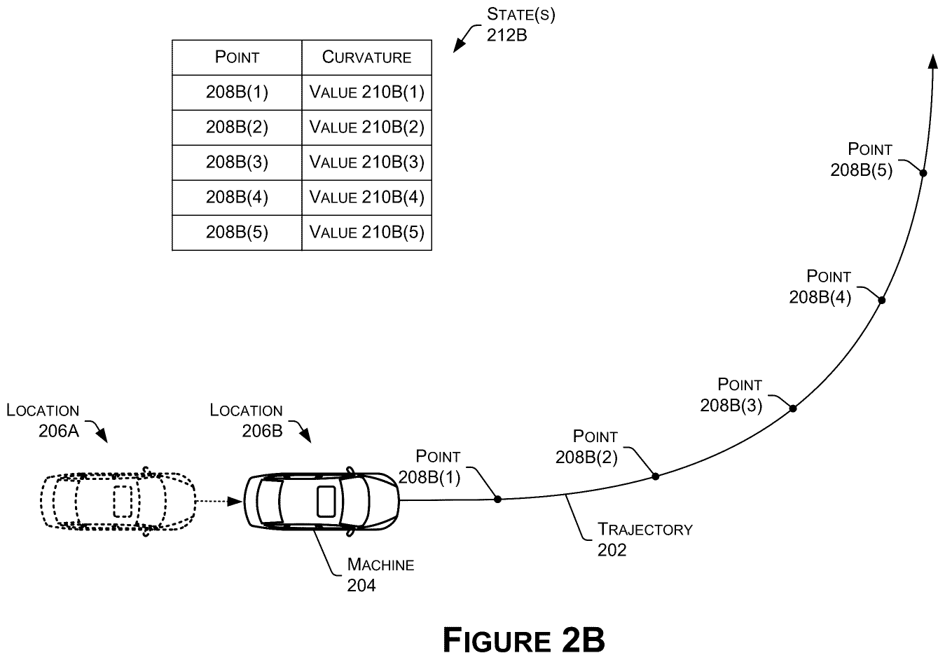

For example, FIGS. 2A and 2B illustrate example curvature values that may be determined for points 208A(1)-208A(5) along a trajectory 202 of a machine 204 when the machine 204 is at different locations, in accordance with some embodiments of the present disclosure. The machine 204 may correspond to the machine 900, in some examples. Referring first to FIG. 2A, the values 210A(1)-210A(5) may correspond to magnitudes of curvature at the respective points 208 along the trajectory 202 when the machine 204 is at the first location 206A. For instance, the first value 210A(1) may represent a first magnitude of curvature at the first point 208A(1), the second value 210A(2) may represent a second magnitude of curvature at the second point 208A(2), the third value 210A(3) may represent a third magnitude of curvature at the third point 208A(3), the fourth value 210A(4) may represent a fourth magnitude of curvature at the fourth point 208A(4), and the fifth value 210A(5) may represent a fifth magnitude of curvature at the fifth point 208A(5). The values 210A for the points 208A(1)-208A(5) may correspond to one or more first states 212A associated with the Kalman filter 102. Each of the points 208 may be separated by a specific offset distance, such as 5 meters, 10 meters, etc. Although described in the example of FIG. 2A as being associated with the trajectory 202 of the machine 204, the curvatures may additionally, or alternatively, be associated with the curvature of a driving surface, such as a road. In the context of both of FIGS. 2A and 2B, the curvature values 210A for the points 208A may correspond to the previous curvature(s) 110, as will become more apparent in the explanation below of FIG. 2B.

Referring now to FIG. 2B, the machine 204 may move from the first location 206A to a second location 206B, and second values 210B(1)-210B(5) may be predicted for the curvature at the points 208B(1)-208B(5), which may correspond to the same or different locations in an environment as the points 208A(1)-208A(5). For instance, the first value 210B(1) may represent a first magnitude of curvature at the first point 208B(1), the second value 210B(2) may represent a second magnitude of curvature at the second point 208B(2), the third value 210B(3) may represent a third magnitude of curvature at the third point 208B(3), the fourth value 210B(4) may represent a fourth magnitude of curvature at the fourth point 208B(4), and the fifth value 210B(5) may represent a fifth magnitude of curvature at the fifth point 208B(5). The values 210B for the points 208B(1)-208B(5) may correspond to one or more second states 212B associated with the Kalman filter 102. In some examples, the values 210B may be interpolated from the values 210A based on the distance the machine 204 moved between the first location 206A and the second location 206B. In at least one example, the value 210B(5) for the point 208B(5) may be extrapolated based at least on the values 210B(1)-210B(4) and/or the values 210A(1)-210A(5).

In some examples, the process model(s) 106 may determine the predicted curvature(s) 108 using interpolation and/or extrapolation based at least on the previous curvature(s) 110 and the distance the machine moved ahead since the previous curvature(s) 110 were determined. For example, the process model(s) 106 may interpolate the values 210B(2)-210B(5) from the values 210A(1)-210A(5) based on the distance the machine moved ahead, and extrapolate the value 210B(6) based on the values 210B(2)-210B(5). In some examples, at a given timestamp k, the process model(s) 106 may determine the predicted curvature(s) 108 as state(s) of the Kalman filter 102. For a current state of the Kalman filter 102, the curvatures may be represented mathematically using the matrix:

$${S}_{k} = [ \begin{matrix}{C}_{0 , k} \\ {C}_{1 , k} \\ ⋮ \\ {C}_{n - 1 , k}\end{matrix} ]$$

where Sₖ is the state of the Kalman filter at timestamp k, and C is the curvature at point n that is located some distance l from the machine. For example, C₀ may represent the curvature at the machine, C₁ may represent the curvature for a first point along the driving surface that is 5 meters ahead of the machine, C₂ may represent the curvature for a second point along the driving surface that is 10 meters ahead of the machine, and so forth.

In some examples, the current state of the Kalman filter (e.g., the predicted curvature(s) 106) may be computed using the equation(s):

$${\hat{S}}_{k} = {A}_{k - 1} \cdot {S}_{k - 1} \qquad ( 1 )$$

$${\hat{P}}_{k} = {A}_{k} \cdot {P}_{k - 1} \cdot {A}_{k}^{T} + {Q}_{k} \qquad ( 2 )$$

$$\text{where:}$$

$${S}_{k - 1} = [ \begin{matrix}{C}_{0 , k - 1} \\ {C}_{1 , k - 1} \\ ⋮ \\ {C}_{n - 1 , k - 1}\end{matrix} ] , \qquad ( 3 )$$

$${A}_{k - 1} = [ \begin{matrix}N & Δ & 0 & 0 & … & 0 \\ 0 & N & Δ & 0 & … & 0 \\ ⋮ & & & & & \\ 0 & … & 0 & N & Δ & 0 \\ 0 & … & 0 & 0 & N & Δ \\ 0 & … & 0 & 0 & - Δ & Y\end{matrix} ] , \qquad ( 4 )$$

$${Q}_{k} = [ \begin{matrix}{q}_{k} \\ ⋮ \\ {q}_{k}\end{matrix} ] . \qquad ( 5 )$$

In equation (1), Ŝₖ may correspond to the estimated state. In equation (2), \hat{P}ₖ may correspond to the estimated covariance. Furthermore, in equations (3)-(5), qₖ=const·dl², N=1−Δ, Y=1+Δ, δ represents the sampling distance (e.g., 1 m, 5 m, 10 m, etc.) between points, dl represents the moved distance by the machine subsequent to the previous state, and

$$Δ = \frac{dl}{δ} ,$$

which represents the portion of the distance moved relative to the sampling distance, assuming that dl≤δ.

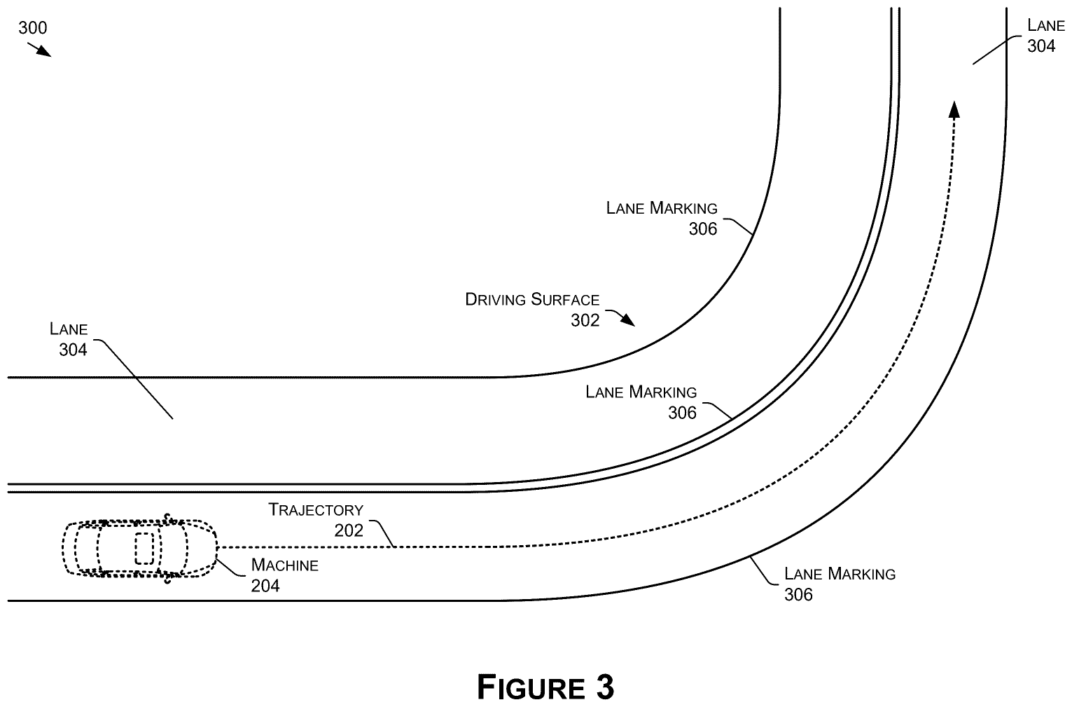

Referring back to the example of FIG. 1, the process 100 may include the measurement model(s) 104 generating the updated curvature(s) 112 based at least on the predicted curvature(s) 108 and the measured curvature(s) 114A and 114B. The measured curvature(s) 114A may be determined by a map curvature component 118 based at least on map data 120. For instance, the map curvature component 118 may obtain the map data 120 corresponding to a current location of the machine, and determine the measured curvature(s) 114A using the map data 120. For example, FIG. 3 illustrates an example map 300 associated with a driving surface that may be represented using the map data 120, in accordance with some embodiments of the present disclosure. The map 300 may be representative of various features associated with an environment the machine 204 is operating in. For instance, the map 300 may represent the driving surface 302 the machine 204 is operating on, as well as various features of the driving surface, such as lanes 304 and lane markings 306. In some examples, a representation of the machine 204 and its trajectory 202 may be overlaid on the map 300, as shown in FIG. 3. In some examples, the map 300 may include the measured curvature(s) 114A or the measured curvature(s) 114A may be computed from the map data 120 by the map curvature component 118. For instance, the map curvature component 118 may convert map curvatures to state values for the Kalman filter 102.

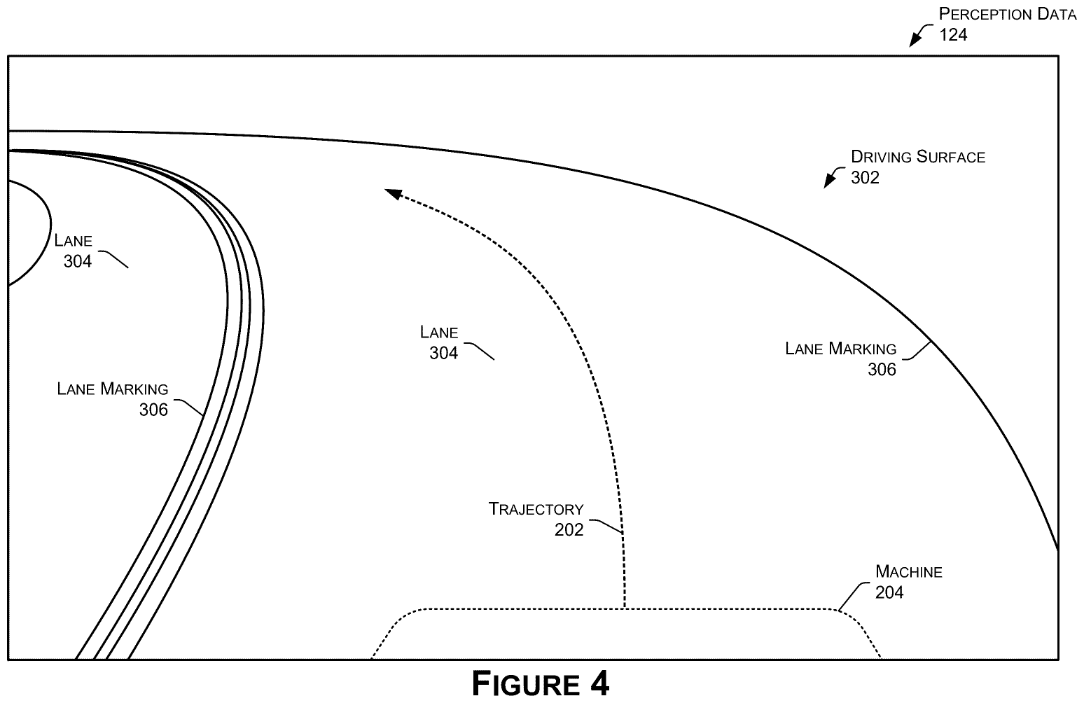

The measured curvature(s) 114B may be determined by a perceived curvature component 122 based at least on perception data 124. The perception data 124 may be generated by a perception system(s) based on sensor data generated using one or more sensors of the machine. For instance, the sensor(s) may include any one or more of LiDAR sensors, RADAR sensors, ultrasonic sensors, image sensors, or any other type of sensors. As such, the sensor data may include any one or more of LiDAR data, RADAR data, ultrasonic data, image data, or any other type of sensor data. In some examples, the perception data 124 may represent a perceived view of the environment from a perspective of the machine. For instance, FIG. 4 illustrates example perception data 124 that may be generated based on sensor data, in accordance with some embodiments of the present disclosure. The perception data 124 may represent a scene of the environment from a perspective of the machine 204. As such, the perception data 124 may represent the driving surface 302, the lanes 304, and the lane markings 306, as well as other features associated with the environment, such as objects (not shown), locations of those objects, environmental conditions (e.g., rain, snow, fog, etc.), and other phenomena that may be perceived by a human. The perception data 124 may also be indicative of the measured curvature(s) 114B, which may also be referred to herein as “perceived curvatures” when determined from perception data. In some instances, the perception data 124 may include or indicate the measured curvature(s) 114B. Additionally, or alternatively, the perceived curvature component 122 may compute the measured curvature(s) 114B from the perception data (e.g., using one or more image processing algorithms, machine learning models, etc.). In some instances, the perceived curvature component 122 may convert the perceived curvatures to state values for the Kalman filter 102.

Referring back to the example of FIG. 1, the process 100 may include the measurement model(s) 104 updating (e.g., refining) one or more (e.g., a subset) of the predicted curvature(s) 108. For instance, the measurement model(s) 104 may update the subset of the predicted curvature(s) 108 associated with the portion(s) of the driving surface so that the updated curvature(s) 112 more accurately represent the actual curvature(s) associated with those portion(s) of the driving surface. The measurement model(s) 104 may update the predicted curvature(s) 108 based at least on the measured curvatures 114A and/or 114B.

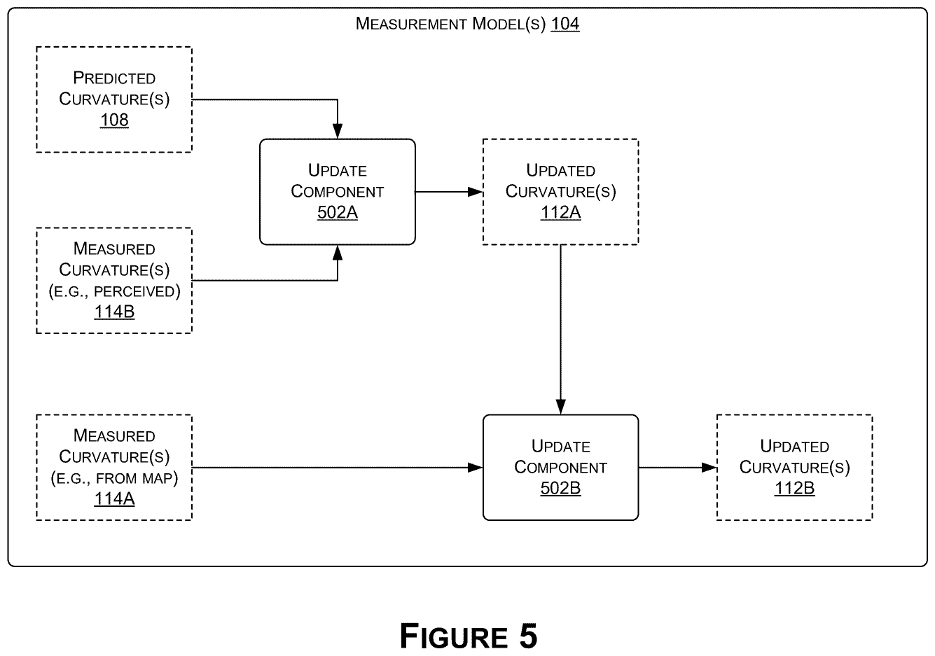

For example, FIG. 5 is a data flow diagram illustrating an example process 500 in which the measurement model(s) 104 may update curvatures based on different sources of information, in accordance with some embodiments of the present disclosure. As illustrated in FIG. 5, the measurement model(s) 104 may perform more than one iteration of updates to the predicted curvature(s) 108 based on the measured curvature(s) 114A and 114B. For example, a first update component 502A of the measurement model(s) 104 may update a first subset (e.g., one, multiple, all, etc.) of the predicted curvature(s) 108 based at least on measured curvature(s) 114B from the perception data. As described herein, the first update component 502A may update the first subset of the predicted curvature(s) 108 to reduce one or more differences between the predicted curvature(s) 108 and corresponding ones of the measured curvature(s) 114B. The first update component 502A may output one or more first updated curvature(s) 112A, which may include the predicted curvature(s) 108 and/or the subset of the updated predicted curvature(s) 108.

Additionally, or alternatively, the measurement model(s) 104 may update a second subset (e.g., one, multiple, all, etc.) of the predicted curvature(s) 108 based at least on the measured curvature(s) 114A from the map data. That is, the second update component 502B may update one or more of the first updated curvature(s) 112A based at least on the measured curvature(s) 114A to generate second updated curvature(s) 112B. In some examples, the second updated curvature(s) 112B may include one or more curvature values (e.g., states) that were updated by a first amount using the first update component 502A, and then updated a second amount using the second update component 502B. in some examples, the second updated curvature(s) 112B may correspond to the updated curvatures 112 of FIG. 1.

Although described in the example of FIG. 5 as being sequential updates, this is not intended to be limiting, and the predicted curvature(s) 108 may be updated in a number of ways based on the measured curvature(s) 114A and/or 114B. For instance, the first measured curvature(s) 114A and the second measured curvature(s) 114B may be aggregated, averaged, weighted, or the like, and then the predicted curvature(s) 108 may be updated a single time based on the combination of the first and second measured curvature(s) from the perception data and the map data.

In some examples, the measurement model(s) 104 may determine whether to update the predicted curvature(s) 108 based on differences between the predicted curvature(s) 108 and the measured curvature(s) 114. For instance, the measurement model(s) 104 may evaluate the values of the predicted curvature(s) 108 with respect to values of the measured curvature(s) 114. In some instances, the measurement model(s) 104 may determine to update the values of the predicted curvature(s) 108 if those values differ from the values of the measured curvature(s) by more than a threshold. For example, if only minor differences exist between the predicted curvature(s) 108 and the measured curvature(s), the system(s) may only update some of the curvature predictions by a minor amount, or not at all. However, if more than minor differences (e.g., major differences) exist between the predicted curvature(s) 108 and the measured curvature(s), then the system(s) may update the values accordingly to reduce the differences.

In some examples, the system(s) may determine to update the values of the predicted curvature(s) 108 if those values differ from a combination or aggregate of the measured curvatures from the different sources. For instance, if the measurement model(s) 104 (or another component/module not shown) determine that the predicted curvature(s) 108 are similar to the measured curvature(s) 114A from the map, but differ from measured/perceived curvatures from the perception data, then the measurement model(s) 104 may refrain from updating the predicted curvature(s) 108. Alternatively, or additionally, the measurement model(s) 104 may still update the predicted curvature(s) 108 if, for instance, a high confidence is assigned to the perception data and its corresponding measured curvature(s) 114B. As another example, if the measurement model(s) 104 determine that the predicted curvature(s) 108 are different (e.g., by more than a threshold) from the measured curvature(s) from both the map data and the perception data, then the measurement model(s) 104 may update the predicted curvature(s) 108 (e.g., assuming the measured curvatures are in agreement from both sources). Additionally, if the measurement model(s) 104 determine that the measured curvature(s) from both the map data and the perception data agree with one another (e.g., differ by less than a threshold), than the measurement model(s) 104 may update one or more of the predicted curvature(s) 108 that disagree with the measured curvature(s) 114A and/or 114B.

In some examples, at a given timestamp k, the measurement model(s) 104 may determine the updated curvature(s) 112 as updated state(s) of the Kalman filter 102. For a current state of the Kalman filter 102, the measurement model(s) 104 may compute a Kalman gain, the estimated state, and the estimated covariance at some timestamp, k, as:

$${K}_{k} = {\hat{P}}_{k} \cdot {{H}_{k}^{T} ( {H}_{k} {\hat{P}}_{k} {H}_{k}^{T} + {R}_{k} )}^{- 1} \qquad ( 6 )$$

$${S}_{k} = {\hat{S}}_{k} + {K}_{k} ( {Z}_{k}^{m} - {H}_{k} {\hat{S}}_{k} ) \qquad ( 7 )$$

$${P}_{k} = ( I - {K}_{k} {H}_{k} ) {\hat{P}}_{k} \qquad ( 8 )$$

where Ŝₖ represents the predicted state, Zₖ^{m} represents the measurement state, Hₖ represents the observation model, Kₖ represents the Kalman gain, Sₖ represents the estimated state, and Pₖ represents the estimated covariance. In such examples, the estimated state Sₖ and the estimated covariance Pₖ may correspond to an output of the measurement model(s) 104.

Referring back to the example of FIG. 1, the process 100 may include the updated curvature(s) 112 (e.g., the updated value(s)/state(s)) being provided to the downstream component(s) 116 of the machine, as well as being used as the next set of the previous curvature(s) 110 for the Kalman Filter 102. For instance, the updated curvature(s) 112 may be used by the downstream component(s) 116 for planning a path for the machine to follow, adjusting trajectory of the machine, such as adjusting steering angle, updating maximum operating speeds, and/or the like, making predictions about other agents in the environment, etc. In some examples, the downstream component(s) 116 may plot the updated curvature(s) 112 (e.g., as a lane graph) to determine how to control the machine.

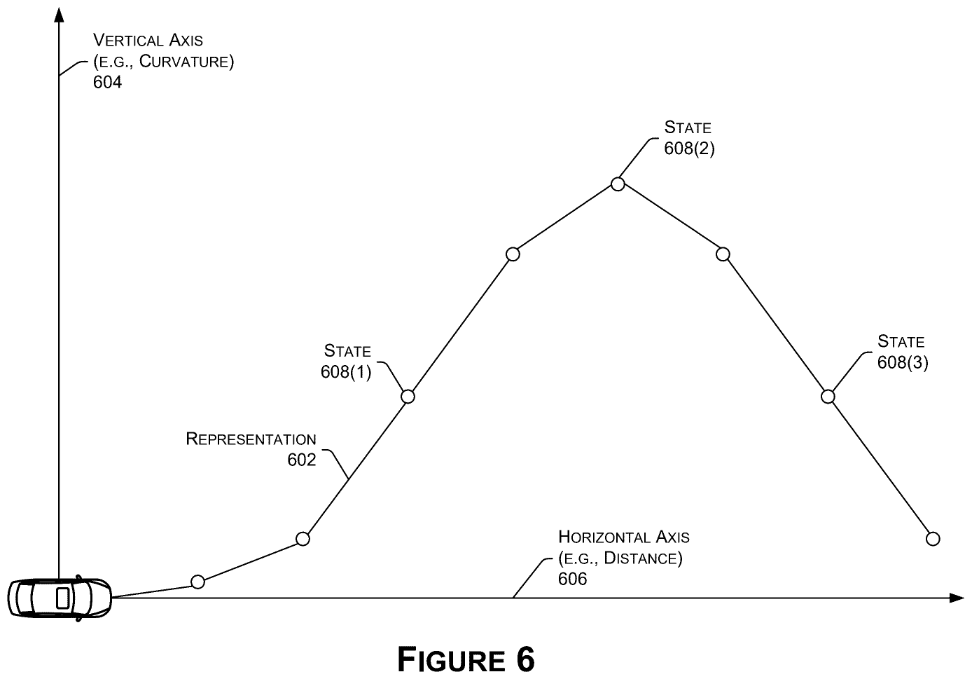

For instance, FIG. 6 illustrates an example graphical representation 602 of magnitudes of curvature associated with different portions of a driving surface, in accordance with some embodiments of the present disclosure. The representation 602 may represent the curvature of a portion(s) of a drivable surface, such as a bend or corner in the drivable surface. The representation 602 may be generated by plotting the curvature values for the states (e.g., states 608(1)-608(3)) of the Kalman filter 102 against the vertical axis 604 (e.g., curvature axis) and the horizontal axis 606 (e.g., distance from machine). The values of the states 608(1)-608(3) may correspond to respective ones of the values 210 associated with the points 208, as described in the example of FIGS. 2A and 2B. As such, the representation 602 may be representative of the curvature throughout a bend in a driving surface, such as a 90-degree corner. For instance, the state 608(1) may correspond to an initial portion of the corner, such as point 208A(3) in FIG. 2A, where the curvature is not at maximum. However, the state 608(2) may correspond to the midpoint of the corner, such as point 208A(4) in FIG. 2A, where the curvature of the trajectory 202 is at its maximum point. After this, the curvature may decrease (e.g., states 608(3) and onward) as the drivable surface straightens back out, for instance.

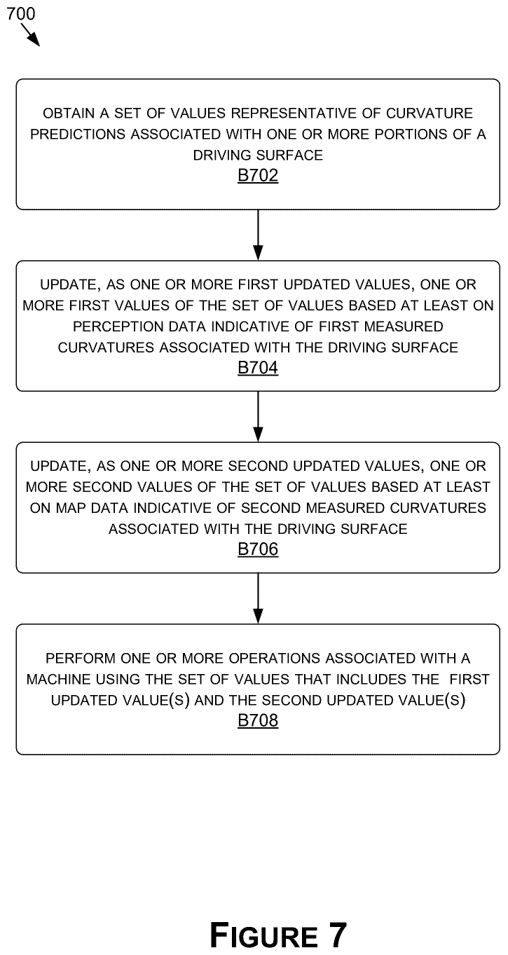

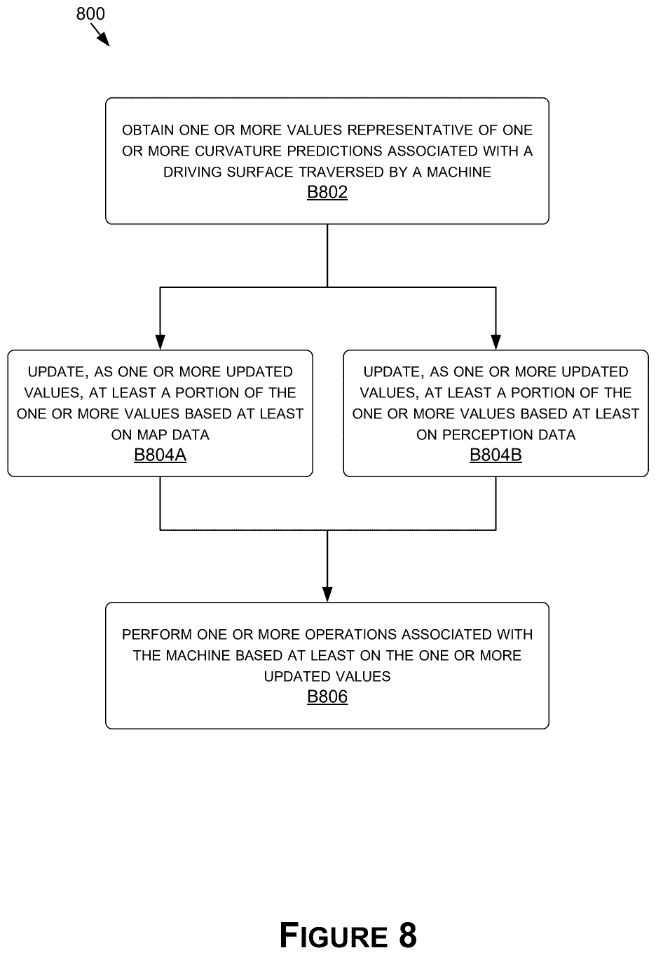

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 700 and 800 are described, by way of example, with respect to FIG. 1. However, these methods may additionally or alternatively be executed by any one system, or any combination of systems, including, but not limited to, those described herein.

FIG. 7 is a flow diagram illustrating an example method 700 for estimating curvature associated with a driving surface, in accordance with some embodiments of the present disclosure. The method 700, at block B702, may include obtaining a set of values representative of curvature predictions associated with one or more portions of a driving surface. For instance, the measurement model(s) 104 may obtain the set of values representative of the predicted curvature(s) 108 associated with the portion(s) of the driving surface. In some examples, the set of values representative of the curvature predictions may be determined based at least on one or more previously determined curvatures associated with one or more second portions of the driving surface and on a distance of travel of a machine subsequent to the determination of the previously determined curvatures.

The method 700, at block B704, may include updating, as one or more first updated values, one or more first values of the set of values based at least on perception data indicative of first measured curvatures associated with the driving surface. For instance, the measurement model(s) 104 may update, as the first updated value(s), the first value(s) of the set of values of the predicted curvature(s) 108 based at least on the perception data 124 indicative of the measured curvature(s) 114B associated with the driving surface. In some examples, the perception data may be generated based at least on sensor data obtained using one or more sensors of a machine. In some examples, updating the first value(s) based on the perception data may reduce one or more differences between the first value(s) (e.g., the curvature predictions) and the first measured curvatures.

The method 700, at block B706, may include updating, as one or more second updated values, one or more second values of the set of values based at least on map data indicative of second measured curvatures associated with the driving surface. For instance, the measurement model(s) 104 may update, as the second updated value(s), the second value(s) of the set of values of the predicted curvature(s) 108 based at least on the map data 120 indicative of the measured curvature(s) 114A associated with the driving surface. In some examples, updating the second value(s) based on the map data may reduce one or more differences between the second value(s) (e.g., the curvature predictions) and the second measured curvatures.

The method 700, at block B708, may include performing one or more operations associated with a machine using the set of values that includes the one or more first updated values and the one or more second updated values. For instance, the set of values may correspond to the updated curvature(s) 112 and include the first updated value(s) and the second updated value(s). In some instances, the operation(s) associated with the machine may include altering a trajectory of the machine, adjusting a behavior of the machine, predicting behavior of one or more agents in an environment surrounding the machine, and/or the like.

FIG. 8 is a flow diagram illustrating an example method 800 for updating predicted curvatures associated with a driving surface based on map data or perception data, in accordance with some embodiments of the present disclosure. The method 800, at block B802, may include obtaining one or more values representative of one or more curvature predictions associated with a driving surface traversed by a machine. For instance, the measurement model(s) 104 may obtain the value(s) corresponding to the predicted curvature(s) 108 representative of the curvature prediction(s) associated with the driving surface. In some examples, the value(s) representative of the curvature prediction(s) may be determined based at least on one or more previously determined curvatures associated with one or more portions of the driving surface and on a distance of travel of the machine subsequent to the determination of the previously determined curvatures.

The method 800, at block B804A, may include updating, as one or more updated values, at least a portion of the one or more values based at least on map data. For instance, the measurement model(s) 104 may update the portion of the value(s) based at least on the map data. In some examples, updating the portion of the value(s) based on the map data may reduce one or more differences between the portion of the value(s) (e.g., the curvature predictions) and curvatures from the map data.

The method 800, at block B804B, may include updating, as one or more updated values, at least a portion of the one or more values based at least on perception data. For instance, the measurement model(s) 104 may update the portion of the value(s) based at least on the perception data. In some examples, the perception data may be generated based at least on sensor data obtained using one or more sensors of the machine. In some examples, updating the portion of the value(s) based on the perception data may reduce one or more differences between the portion of the value(s) (e.g., the curvature predictions) and curvatures from the perception data.

In some examples, blocks B804A and B804B may be performed in addition to one another and/or in the alternative of one another. That is, in some examples, the portion of the value(s) may be updated based at least on the map data or on the perception data, or based at least on both of the map data and the perception data.

The method 800, at block B806, may include performing one or more operations associated with the machine based at least on the one or more updated values. For instance, the updated value(s) may correspond to the updated curvature(s) 112. In some instances, the operation(s) associated with the machine may include altering a trajectory of the machine, adjusting a behavior of the machine, predicting behavior of one or more agents in an environment surrounding the machine, and/or the like.

### Example Autonomous Vehicle

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 900 may be capable of functionality in accordance with one or more of Level 3-Level 5 of the autonomous driving levels. The vehicle 900 may be capable of functionality in accordance with one or more of Level 1-Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to enable the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to enable autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LIDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), and/or other sensor types.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 900 further includes a network interface 924 which may use one or more wireless antenna(s) 926 and/or modem(s) to communicate over one or more networks. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 924 from one or more servers (e.g., server(s) 978 of FIG. 9D).

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation enabling any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LIDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 912 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to enable communication with peripherals, audio codecs, power management, and/or other devices. The SoC(s) 904 may be used to process data from cameras (e.g., connected over Gigabit Multimedia Serial Link and Ethernet), sensors (e.g., LIDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 924 which may include one or more wireless antennas 926 (e.g., one or more wireless antennas for different communication protocols, such as a cellular antenna, a Bluetooth antenna, etc.). The network interface 924 may be used to enable wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated by the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 960 m (front) or 80 m (rear), and a field of view of up to 42 degrees (front) or 950 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LIDAR sensor(s) 964. The LIDAR sensor(s) 964 may be used for object and pedestrian detection, emergency braking, collision avoidance, and/or other functions. The LIDAR sensor(s) 964 may be functional safety level ASIL B. In some examples, the vehicle 900 may include multiple LIDAR sensors 964 (e.g., two, four, six, etc.) that may use Ethernet (e.g., to provide data to a Gigabit Ethernet switch).

In some examples, the LIDAR sensor(s) 964 may be capable of providing a list of objects and their distances for a 360-degree field of view. Commercially available LIDAR sensor(s) 964 may have an advertised range of approximately 900 m, with an accuracy of 2 cm-3 cm, and with support for a 900 Mbps Ethernet connection, for example. In some examples, one or more non-protruding LIDAR sensors 964 may be used. In such examples, the LIDAR sensor(s) 964 may be implemented as a small device that may be embedded into the front, rear, sides, and/or corners of the vehicle 900. The LIDAR sensor(s) 964, in such examples, may provide up to a 120-degree horizontal and 35-degree vertical field-of-view, with a 200 m range even for low-reflectivity objects. Front-mounted LIDAR sensor(s) 964 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 900. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may enable the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in driving surfaces. In another example, when two or more vibration sensors 942 are used, the differences between the vibrations may be used to determine friction or slippage of the driving surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LIDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 924 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 900), while the I2V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. In other words, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984(A)-984(H) (collectively referred to herein as GPUs 984), PCIe switches 982(A)-982(H) (collectively referred to herein as PCIe switches 982), and/or CPUs 980(A)-980(B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161 (N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: obtaining a set of values representative of curvature predictions associated with one or more portions of a driving surface; updating, as one or more first updated values, one or more first values of the set of values based at least on perception data indicative of one or more first measured curvatures associated with the driving surface; updating, as one or more second updated values, one or more second values of the set of values based at least on map data indicative of one or more second measured curvatures associated with the driving surface; and performing one or more operations associated with a machine using the set of values that includes the one or more first updated values and the one or more second updated values.

B. The method as recited in paragraph A, wherein individual values of the set of values correspond to magnitudes of curvature associated with the curvature predictions for the one or more portions of the driving surface.

C. The method as recited in any one of paragraphs A-B, further comprising determining the set of values representative of the curvature predictions based at least on a trajectory of the machine and on one or more previous predictions of curvature associated with one or more second portions of the driving surface.

D. The method as recited in any one of paragraphs A-C, wherein the trajectory of the machine comprises a distance of travel of the machine subsequent to determining the one or more previous predictions of curvature associated with the one or more second portions of the driving surface.

E. The method as recited in any one of paragraphs A-D, further comprising: determining, based at least on the perception data, that one or more differences between one or more of the curvature predictions and the one or more first measured curvatures meet or exceed a threshold, wherein the updating of the one or more first values of the set of values is based at least on the one or more differences meeting or exceeding the threshold.

F. The method as recited in any one of paragraphs A-E, further comprising: determining, based at least on the map data, that one or more differences between one or more of the curvature predictions and the one or more second measured curvatures meet or exceed a threshold, wherein the updating of the one or more second values of the set of values is based at least on the one or more differences meeting or exceeding the threshold.

G. The method as recited in any one of paragraphs A-F, wherein: the updating of the one or more first values of the set of values reduces one or more first differences between one or more first curvature predictions of the curvature predictions and one or more first curvature measurements from the perception data; and the updating of the one or more second values of the set of values reduces one or more second differences between one or more second curvature predictions of the curvature predictions and one or more second curvature measurements from the map data.

H. The method as recited in any one of paragraphs A-G, further comprising updating at least one value of the one or more second values that corresponds to at least one of the one or more first updated values, the at least one value updated, as part of the one or more second updated values, based at least on the map data indicating a difference in the at least one value between the one or more first measured curvatures and the one or more second measured curvatures.

I. A system comprising: one or more processors to: obtain one or more values representative of one or more curvature predictions associated with a driving surface traversed by a machine; update, as one or more updated values, at least a portion of the one or more values based at least on at least one of: map data associated with the driving surface; or perception data generated based at least on sensor data obtained using one or more sensors of the machine; and perform one or more operations associated with the machine based at least on the one or more updated values.

J. The system as recited in paragraph I, the one or more processors further to: determine, based at least on the map data, one or more second values representative of one or more curvature measurements associated with the driving surface, wherein one or more magnitudes of the one or more updated values are based at least on the one or more second values.

K. The system as recited in any one of paragraphs I-J, the one or more processors further to: determine, based at least on the perception data, one or more second values representative of one or more curvature measurements associated with the driving surface, wherein one or more magnitudes of the one or more updated values are based at least on the one or more second values.

L. The system as recited in any one of paragraphs I-K, wherein the one or more values are representative of one or more predicted magnitudes of curvature corresponding to one or more portions of the driving surface.

M. The system as recited in any one of paragraphs I-L, the one or more processors further to determine the one or more values representative of the one or more curvature predictions based at least on one or more second values representative of one or more previous curvature predictions associated with the driving surface.

N. The system as recited in any one of paragraphs I-M, the one or more processors further to determine the one or more values representative of the one or more curvature predictions based at least on a trajectory of the machine subsequent to a determination of one or more previous curvature predictions associated with the driving surface.

O. The system as recited in any one of paragraphs I-N, wherein the update of the at least the portion of the one or more values reduces one or more differences between the at least the portion of the one or more values and one or more second values representative of one or more curvature measurements associated with the driving surface, the one or more second values determined based at least on at least one of the map data or the perception data.

P. The system as recited in any one of paragraphs I-O, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

Q. At least one processor comprising: one or more circuits to perform one or more operations associated with a machine based at least on estimations of curvature corresponding to one or more portions of a driving surface, the estimations of curvature determined by updating one or more predicted curvatures associated with the one or more portions of the driving surface based at least on map data indicative of one or more measured curvatures associated with the one or more portions of the driving surface.

R. The processor as recited in paragraph Q, the one or more circuits to further update the predicted curvatures based at least on perception data generated from at least sensor data obtained using one or more sensors of the machine, the perception data indicative of one or more second predicted curvatures associated with the one or more portions of the driving surface.

S. The processor as recited in any one of paragraphs Q-R, wherein the one or more predicted curvatures are determined based at least on one or more previous estimations of curvature corresponding to one or more second portions of the driving surface.

T. The processor as recited in any one of paragraphs Q-S, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining a set of values representative of curvature predictions associated with one or more portions of a driving surface;
updating, as one or more first updated values, one or more first values of the set of values based at least on perception data indicative of one or more first measured curvatures associated with the driving surface;
updating, as one or more second updated values, one or more second values of the set of values based at least on map data indicative of one or more second measured curvatures associated with the driving surface; and
performing one or more operations associated with a machine using the set of values that includes the one or more first updated values and the one or more second updated values.

2. The method of claim 1, wherein individual values of the set of values correspond to magnitudes of curvature associated with the curvature predictions for the one or more portions of the driving surface.

3. The method of claim 1, further comprising determining the set of values representative of the curvature predictions based at least on a trajectory of the machine and on one or more previous predictions of curvature associated with one or more second portions of the driving surface.

4. The method of claim 3, wherein the trajectory of the machine comprises a distance of travel of the machine subsequent to determining the one or more previous predictions of curvature associated with the one or more second portions of the driving surface.

5. The method of claim 1, further comprising:
determining, based at least on the perception data, that one or more differences between one or more of the curvature predictions and the one or more first measured curvatures meet or exceed a threshold,
wherein the updating of the one or more first values of the set of values is based at least on the one or more differences meeting or exceeding the threshold.

6. The method of claim 1, further comprising:
determining, based at least on the map data, that one or more differences between one or more of the curvature predictions and the one or more second measured curvatures meet or exceed a threshold,
wherein the updating of the one or more second values of the set of values is based at least on the one or more differences meeting or exceeding the threshold.

7. The method of claim 1, wherein:
the updating of the one or more first values of the set of values reduces one or more first differences between one or more first curvature predictions of the curvature predictions and one or more first curvature measurements from the perception data; and
the updating of the one or more second values of the set of values reduces one or more second differences between one or more second curvature predictions of the curvature predictions and one or more second curvature measurements from the map data.

8. The method of claim 1, further comprising updating at least one value of the one or more second values that corresponds to at least one of the one or more first updated values, the at least one value updated, as part of the one or more second updated values, based at least on the map data indicating a difference in the at least one value between the one or more first measured curvatures and the one or more second measured curvatures.

9. A system comprising:
one or more processors to:
obtain one or more values representative of one or more curvature predictions associated with a driving surface traversed by a machine;
update, as one or more updated values, at least a portion of the one or more values based at least on at least one of:
map data associated with the driving surface; or
perception data generated based at least on sensor data obtained using one or more sensors of the machine; and
perform one or more operations associated with the machine based at least on the one or more updated values.

10. The system of claim 9, the one or more processors further to:
determine, based at least on the map data, one or more second values representative of one or more curvature measurements associated with the driving surface,
wherein one or more magnitudes of the one or more updated values are based at least on the one or more second values.

11. The system of claim 9, the one or more processors further to:
determine, based at least on the perception data, one or more second values representative of one or more curvature measurements associated with the driving surface,
wherein one or more magnitudes of the one or more updated values are based at least on the one or more second values.

12. The system of claim 9, wherein the one or more values are representative of one or more predicted magnitudes of curvature corresponding to one or more portions of the driving surface.

13. The system of claim 9, the one or more processors further to determine the one or more values representative of the one or more curvature predictions based at least on one or more second values representative of one or more previous curvature predictions associated with the driving surface.

14. The system of claim 9, the one or more processors further to determine the one or more values representative of the one or more curvature predictions based at least on a trajectory of the machine subsequent to a determination of one or more previous curvature predictions associated with the driving surface.

15. The system of claim 9, wherein the update of the at least the portion of the one or more values reduces one or more differences between the at least the portion of the one or more values and one or more second values representative of one or more curvature measurements associated with the driving surface, the one or more second values determined based at least on at least one of the map data or the perception data.

16. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

17. At least one processor comprising:
one or more circuits to perform one or more operations associated with a machine based at least on estimations of curvature corresponding to one or more portions of a driving surface, the estimations of curvature determined by updating one or more predicted curvatures associated with the one or more portions of the driving surface based at least on map data indicative of one or more measured curvatures associated with the one or more portions of the driving surface.

18. The processor of claim 17, the one or more circuits to further update the predicted curvatures based at least on perception data generated from at least sensor data obtained using one or more sensors of the machine, the perception data indicative of one or more second predicted curvatures associated with the one or more portions of the driving surface.

19. The processor of claim 17, wherein the one or more predicted curvatures are determined based at least on one or more previous estimations of curvature corresponding to one or more second portions of the driving surface.

20. The processor of claim 17, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
